(19) United States
(12) Patent Application Publication
(10) Pub. No.: US 2014/0158270 A1
(43) Pub. Date: Jun. 12, 2014

(54) PNEUMATIC TIRE

(71) Applicant: SUMITOMO RUBBER INDUSTRIES, LTD., Kobe-shi (JP)

(72) Inventor: Tadao MATSUMOTO, Kobe-shi (JP)

(73) Assignee: SUMITOMO RUBBER INDUSTRIES, LTD., Kobe-shi (JP)

(21) Appl. No.: 14/091,531

(22) Filed: Nov. 27, 2013

(30) Foreign Application Priority Data
Dec. 11, 2012 (JP) 2012-270611

(51) Int. Cl. B60C 19/00

(52) U.S. Cl. CPC B60C 19/00
USPC 152/526

(57) ABSTRACT

A pneumatic tire having a tread portion, buttress portions, sidewall portions and bead portions, includes bead cores positioned in the bead portions, respectively, a carcass extending from the tread portion through the sidewall portions to the bead cores in the bead portions, a belt layer formed over the carcass in a tire radial direction in the tread portion and including multiple belt plies, and clinch rubbers positioned over the carcass in a tire axial direction in the bead portions, respectively, and forming outer surfaces in the bead portions. Each of the belt plies has belt cords such that the belt cords are tilted at an angle of 15° to 45° with respect to a tire equator, and each of the clinch rubbers has a thickness in a range of 3 to 5 mm measured at a height of 25 mm from a bead base line in the tire radial direction.

### CROSS-REFERENCE TO RELATED APPLICATIONS

The present application is based upon and claims the benefit of priority to Japanese Patent Application No. 2012-270611, filed Dec. 11, 2012, the entire contents of which are incorporated herein by reference.

### BACKGROUND OF THE INVENTION

1. Field of the Invention

The present invention relates to a pneumatic tire having improved pinch cut resistance and handling stability in a balanced manner while the weight thereof is reduced.

2. Description of the Background Art

In recent years, weight reduction of pneumatic tires has been required in order to improve the fuel consumption of vehicles. Weight reduction of a pneumatic tire is achieved by decreasing (thinning) the thickness of a rubber material constituting mainly an outer surface portion of the tire. The thinned location includes a buttress portion between a tread portion and each sidewall portion. As related art, there is Japanese Laid-Open Patent Publication No. 2008-1138. The entire contents of this publication are incorporated herein by reference.

### SUMMARY OF THE INVENTION

According to one aspect of the present invention, a pneumatic tire has a tread portion, buttress portions, sidewall portions and bead portions, and includes bead cores positioned in the bead portions, respectively, a carcass extending from the tread portion through the sidewall portions to the bead cores in the bead portions, a belt layer formed over the carcass in a tire radial direction in the tread portion and including multiple belt plies, and clinch rubbers positioned over the carcass in a tire axial direction in the bead portions, respectively, and forming outer surfaces in the bead portions. Each of the belt plies has belt cords such that the belt cords are tilted at an angle of 15° to 45° with respect to a tire equator, and each of the clinch rubbers has a thickness in a range of 3 to 5 mm measured at a height of 25 mm from a bead base line in the tire radial direction.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a cross-sectional view of the right half of a pneumatic tire showing one embodiment of the present invention;

FIG. 2 is an enlarged view of a buttress portion in FIG. 1;

FIG. 3 is a partial perspective view of the pneumatic tire in FIG. 1;

FIG. 4 is a development of the tire, showing a carcass ply, belt plies, and buttress reinforcing layers;

FIG. 5(a) is a partial cross-sectional view representing the advantageous effect of an embodiment of the present invention;

FIG. 5(b) is an enlarged view of a bead portion in FIG. 5(a);

FIG. 6 is a plan view explaining a test method for pinch cut resistance; and

FIG. 7 is a partial perspective view showing a pneumatic tire of a conventional example.

### DETAILED DESCRIPTION OF THE EMBODIMENTS

The embodiments will now be described with reference to the accompanying drawings, wherein like reference numerals designate corresponding or identical elements throughout the various drawings.

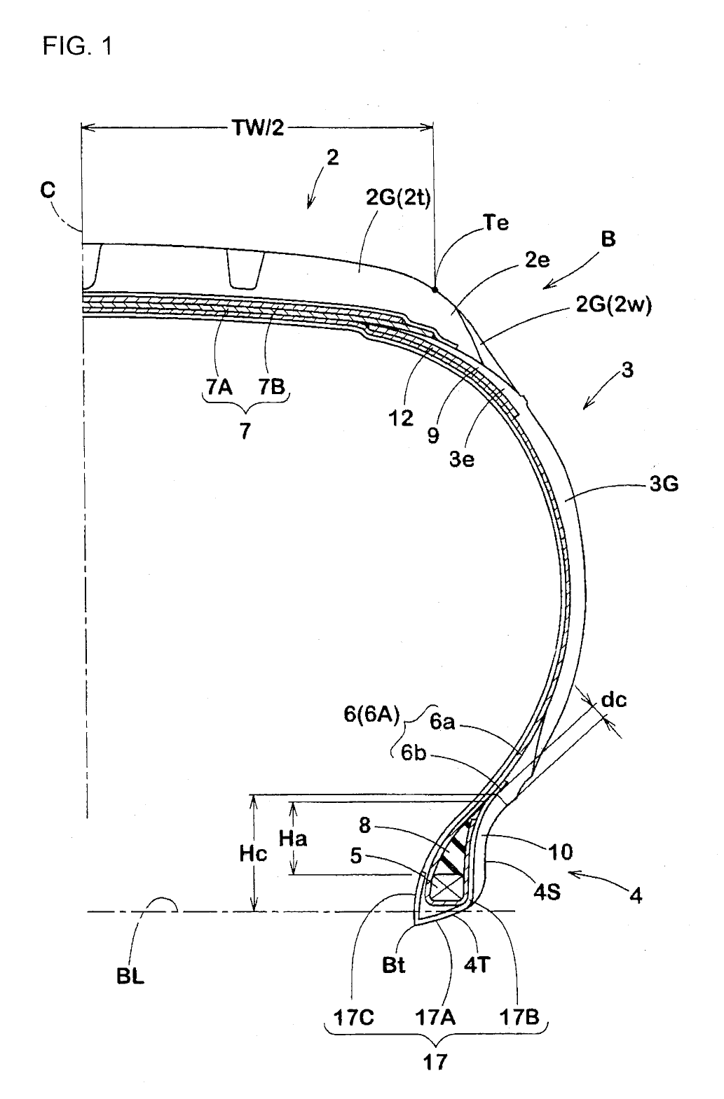

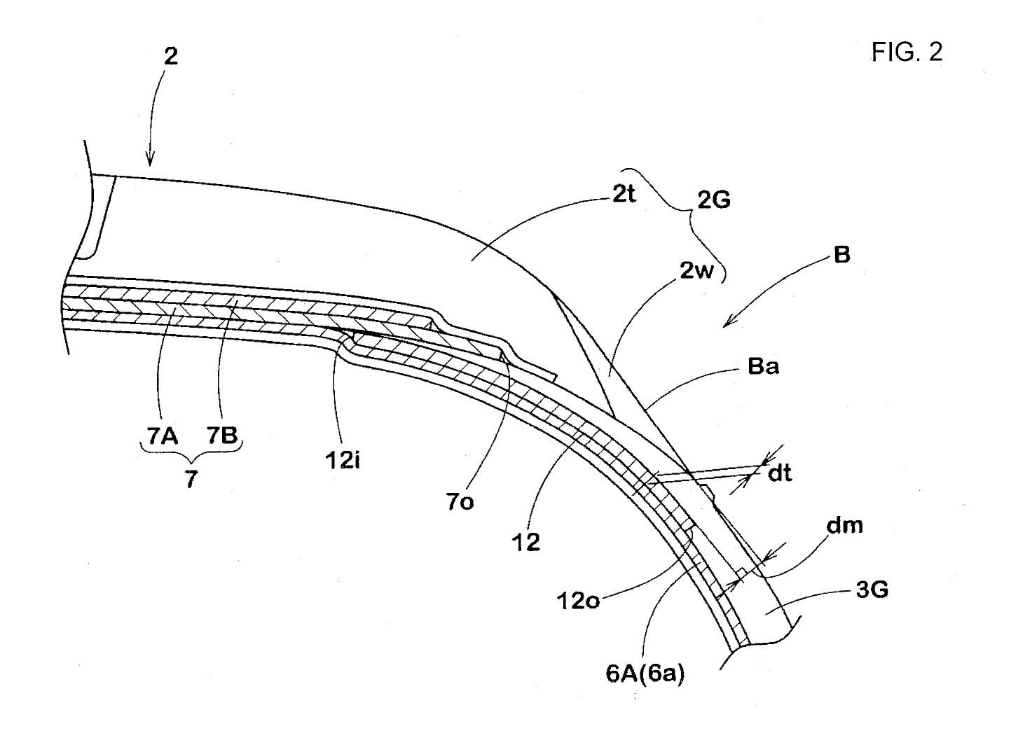

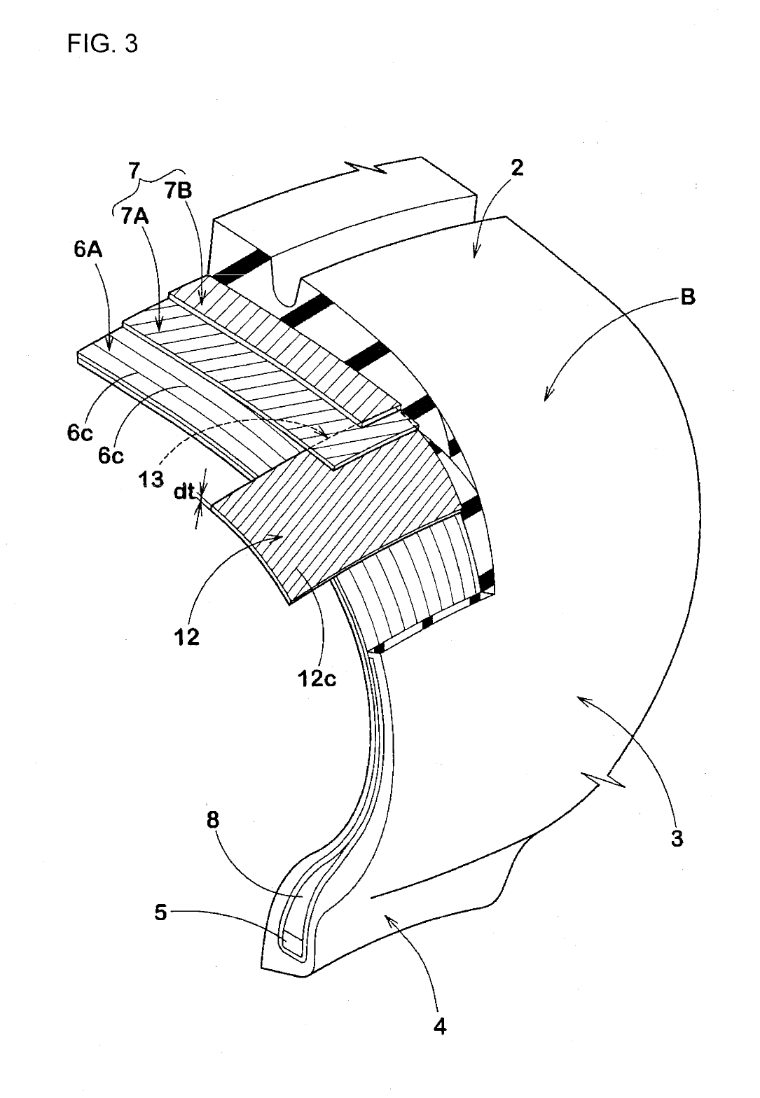

FIG. 1 is a tire meridian cross-sectional view of a pneumatic tire according to the present embodiment (hereinafter, sometimes referred to merely as “tire”) in a normal condition, FIG. 2 is an enlarged view of a buttress portion (B) of the pneumatic tire, and FIG. 3 is a partial perspective view of the tire in FIG. 1. In the present specification, the “normal condition” refers to a condition where the tire is mounted on a normal rim (not shown) and inflated to a normal internal pressure and no load is applied to the tire, and the dimension or the like of each portion of the tire is a value measured in the normal condition unless otherwise specified.

The “normal rim” is a rim specified for every tire by each standard in a standardizing system including standards on which tires are based, and is a “standard rim” in the JATMA standard, a “Design Rim” in the TRA standard, and a “Measuring Rim” in the ETRTO standard. In addition, the “normal internal pressure” is an air pressure specified for every tire by each standard in the standardizing system including the standards on which tires are based, and is a “maximum air pressure” in the JATMA standard, a maximum value recited in the table of “TIRE LOAD LIMITS AT VARIOUS COLD INFLATION PRESSURES” in the TRA standard, and an “INFLATION PRESSURE” in the ETRTO standard.

As shown in FIGS. 1 to 3, a tread rubber (2G) forming the tire surface at a tread portion 2 includes an overlap portion 9 where each outer edge portion (2e), in a tire axial direction, of the tread rubber (2G) covers and overlaps an outer edge portion (3e), in a tire radial direction, of a sidewall rubber (3G) forming the tire surface at each sidewall portion 3. The tread rubber (2G) according to the present embodiment includes a main tread rubber portion (2t) which comes into contact with a road surface, and wing rubber portions (2w) which are disposed at both ends of the main tread rubber portion (2t) and have a triangular cross-sectional shape.

The tire according to the present embodiment has an aspect ratio of 50% to 70% and is for passenger car. The tire includes a carcass 6 extending from the tread portion 2 through the sidewall portions 3 on both sides to bead cores 5 in bead portions 4, and a belt layer 7 disposed outward of the carcass 6 in the tire radial direction and inward of the tread portion 2.

The carcass 6 is formed of one carcass ply (6A) in which a body portion (6a) extends between a pair of the bead cores 5 in a toroidal shape and turned-up portions (6b) are connected to both sides of the main portion (6a) and turned up around the bead cores 5 from the axial inside to the axial outside of the tire.

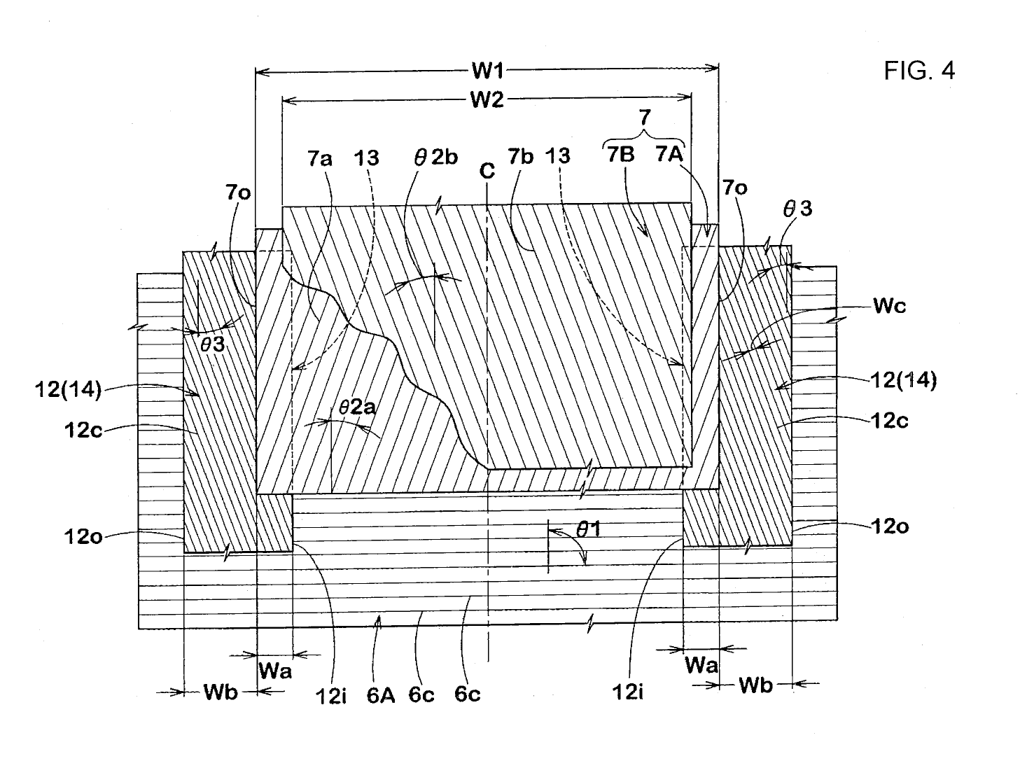

FIG. 4 is a development of the tire, including the carcass ply (6A). As shown in FIG. 4, in the carcass ply (6A), carcass cords (6c) are tilted, for example, at an angle (θ1) of 75° to 95°, at 90° in the present embodiment, with respect to the direction of a tire equator (C). For example, organic fiber cords or steel cords are used as the carcass cords (6c). In the present embodiment, since the carcass ply is defined as a single ply, an increase in the weight of the tire is suppressed.

The belt layer 7 is composed of multiple belt plies. In the present embodiment, the belt layer 7 is composed of two belt plies, namely, a first belt ply (7A) disposed outward of the carcass ply (6A) in the tire radial direction and at an innermost position in the tire radial direction among the belt plies and a second belt ply (7B) disposed outward of the first belt ply (7A) in the tire radial direction.

The belt plies (7A, 7B) have highly elastic belt cords (7a, 7b) tilted within the ranges of angles (θ2a, θ2b) of 15° to 45°, respectively, with respect to the tire equator (C). Such belt plies (7A, 7B) tighten the carcass 6, increase the rigidity of the tread portion 2, and improve the handling stability. In the present embodiment, the belt plies (7A, 7B) are positioned one on top of the other so as to be oriented in such directions, respectively, that the belt cords (7a, 7b) intersect each other. Thus, a further tightening effect is exerted.

As shown in FIG. 1, the belt plies (7A, 7B) according to the present embodiment are positioned one on top of the other such that the width centers thereof are located on the tire equator (C), and continuously extend from a buttress portion (B) on one side in the tire axial direction to a buttress portion (not shown) on another side in the tire axial direction. Thus, a rigidity step in the tread portion 2 is reduced, and the tightening effect of the belt plies (7A, 7B) is exerted greatly on substantially the entirety of the tread portion 2. From such a standpoint, as shown in FIG. 4, each of the widths (W1, W2) of the first belt ply (7A) and the second belt ply (7B) in the tire axial direction is preferably set so as to be 95% to 105% of a ground-contact width (TW) (shown in FIG. 1) which is the distance in the tire axial direction between ground-contact edges (Te). It should be noted that in the present embodiment, the width (W1) of the first belt ply (7A) is larger than the width (W2) of the second belt ply (7B). However, the present invention is not limited to such a mode.

The “ground-contact edges” (Te) are defined as outermost ground-contact positions, in the tire axial direction, on a ground-contact surface of the tire that is in the normal condition and brought into contact with a flat surface at a camber angle of 0° with a normal load applied thereto.

In addition, the “normal load” is a load specified for every tire by each standard in the standardizing system including the standards on which tires are based, and is a “maximum load capacity” in the JATMA standard, a maximum value recited in “TIRE LOAD LIMITS AT VARIOUS COLD INFLATION PRESSURES” in the TRA standard, and a “LOAD CAPACITY” in the ETRTO standard. In the case where the tire is for passenger car, the “normal load” is a load corresponding to 88% of the above load.

In addition, as shown in FIGS. 1 to 3, in the tire according to the present embodiment, a pair of buttress reinforcing layers 12 are provided at the respective buttress portions (B) on both sides and disposed between the carcass 6 and the belt layer 7. Such a pair of buttress reinforcing layers 12 are able to further firmly tighten the carcass 6. Therefore, the rigidity of the buttress portions (B) is increased, and the handling stability is further improved. Moreover, such a tire having high rigidity at the buttress portions (B) is able to suppress a pinch cut, for example, even when running on a protruding object such as a curbstone.

The buttress reinforcing layers 12 according to the present embodiment have reinforcing cords (12c) formed from, for example, polyester, nylon, rayon, aramid, or the like.

As shown in FIG. 4, in the present embodiment, the reinforcing cords (12c) of the buttress reinforcing layers 12 are tilted in a direction opposite to that of the belt cords (7a) of the first belt ply (7A). In other words, the reinforcing cords (12c) are laminated so as to be oriented in such a direction that the reinforcing cords (12c) and the belt cords (7a) intersect each other. By so doing, the rigidity of the buttress portions (B) is further increased, and thus the handling stability is improved.

In each of a case where an angle (θ3) of each reinforcing cord (12c) of the buttress reinforcing layers 12 with respect to a tire circumferential direction is large and a case where the angle (θ3) is small, the angle formed between each belt cord (7a) of the first belt ply (7A) and each reinforcing cord (12c) is excessively decreased, and it is impossible to suppress interval widening of the carcass ply (6A). Thus, the angle (θ3) is preferably not less than 40° and more preferably not less than 45°, and is preferably not greater than 60° and more preferably not greater than 55°.

In the case where the cord interval (Wc) between each reinforcing cord (12c) of each buttress reinforcing layer 12 is large, it is impossible to sufficiently increase the cord density of each buttress portion (B), and there is a concern that it is impossible to increase the handling stability. On the other hand, when the cord interval (Wc) is small, the adjacent reinforcing cords (12c) are in contact with each other, and there is a concern that the durability of each buttress reinforcing layer 12 is decreased. In addition, the rigidity of each buttress portion (B) is excessively increased, and there is a concern that the ride comfort is deteriorated. From such a standpoint, the cord interval (Wc) between each reinforcing cord (12c) is preferably not less than 0.4 mm and more preferably not less than 0.7 mm, and is preferably not greater than 2.0 mm and more preferably not greater than 1.7 mm. It should be noted that in the present specification, the cord interval (Wc) is a minimum interval between the reinforcing cords (12c).

Each buttress reinforcing layer 12 according to the present embodiment extends between an inner edge (12i) located inward, in the tire axial direction, of an outer edge (7o), in the tire axial direction, of the belt layer 7 and an outer edge (12o) located outward, in the tire axial direction, of the outer edge (7o) of the belt layer 7. By so doing, an overlap portion 13 where the belt layer 7 and each buttress reinforcing layer 12 overlap each other in the tire radial direction, and a non-overlap portion 14 where the belt layer 7 and each buttress reinforcing layer 12 do not overlap each other, are formed. Such an overlap portion 13 further suppresses formation of a rigidity step in each buttress portion (B) and further improves the handling stability.

In the case where the width (Wa) of each overlap portion 13 in the tire axial direction is large, there is a concern that the weight of the tire is increased. In the case where the width (Wa) of each overlap portion 13 is small, there is a concern that a rigidity step is formed and the handling stability is deteriorated. Thus, the width (Wa) of each overlap portion 13 is preferably not less than 5 mm and more preferably not less than 7 mm, and is preferably not greater than 15 mm and more preferably not greater than 13 mm.

Similarly, in the case where the width (Wb) of each non-overlap portion 14 in the tire axial direction is large, there is a concern that the weight of the tire is increased. In the case where the width (Wb) of each non-overlap portion 14 is small, the rigidity of each buttress portion (B) is decreased, and there is a concern that the handling stability is deteriorated. Thus, the width (Wb) of each non-overlap portion 14 is preferably not less than 15 mm and more preferably not less than 12 mm, and is preferably not greater than 40 mm and more preferably not greater than 35 mm.

As shown in FIG. 2, the thickness (dt) of each buttress reinforcing layer 12 is not particularly limited, but in order to effectively exert the above-described advantageous effects, the thickness (dt) is preferably not less than 0.5 mm and preferably not greater than 1.2 mm.

In such a pneumatic tire having high rigidity at each buttress portion (B), it is possible to reduce the weight of the tire by decreasing the minimum thickness (dm) of a rubber (formed of the wing rubber portion (2w) or the sidewall rubber (3G)) from the outer surface of each buttress reinforcing layer 12 to the outer surface (Ba) of each buttress portion (B). It should be noted that if the minimum thickness (dm) of the rubber is excessively decreased, the rigidity of each buttress portion (B) is excessively decreased, and there is a concern that a pinch cut occurs. Thus, the minimum thickness (dm) is preferably not less than 4.0 mm and more preferably not less than 4.5 mm, and is preferably not greater than 6.5 mm and more preferably not greater than 6.0 mm. It should be noted that in the present specification, the minimum thickness (dm) is a distance in a normal direction of the buttress reinforcing layer 12.

In addition, as shown in FIG. 1, the tire according to the present embodiment further includes bead apex rubbers 8 which extend from the bead cores 5 outwardly in the tire radial direction and have a substantially triangular cross-sectional shape, clinch rubbers 10 which are disposed in the bead portions 4 and outward of the carcass 6 in the tire axial direction and form outer surfaces (4S) of the bead portions 4, and chafer rubbers 17 which extend around the bead cores 5 in a substantially U shape in a cross section.

The bead apex rubbers 8 extend from the bead cores 5 in a tapered manner. The bead apex rubbers 8 according to the present embodiment are disposed between the body portion (6a) and the turned-up portions (6b) of the carcass 6.

In order to ensure the rigidity of each bead portion 4 and weight reduction of the tire in a balanced manner, the height (Ha) of each bead apex rubber 8 in the tire radial direction is preferably not less than 7 mm and more preferably not less than 9 mm, and is preferably not greater than 20 mm and more preferably not greater than 18 mm.

A rubber hardness of each of such bead apex rubbers 8 is preferably set so as to be 80° to 95°, in order to increase the rigidity of each bead portion 4 and ensure a desired fitting force to a rim. It should be noted that in the present specification, the “rubber hardness” is measured with a JIS type A durometer in the environment at 23° C. according to JIS-K6253.

In the present embodiment, each chafer rubber 17 includes a base portion (17A) which is located inward of the bead core 5 in the radial direction and exposed in a bead bottom surface (4T), an outer standing portion (17B) which is connected to the base portion (17A) and extends outwardly in the tire radial direction along the turned-up portion (6b) of the carcass ply (6A), and an inner standing portion (17C) which is connected to the base portion (17A) and extends from a bead toe (Bt) on the tire inner side outwardly in the tire radial direction.

Each chafer rubber 17 is composed of a steel cord ply in which steel cords are arranged, for example, at an angle of 15° to 60° with respect to the tire circumferential direction, reinforces each bead portion 4 together with each bead apex rubber 8, and improves the durability of each bead portion 4 and the handling stability.

Each clinch rubber 10 according to the present embodiment extends outward of the outer standing portion (17B) and the carcass ply (6A) in the tire axial direction and in an elongated shape, and is exposed as an outer surface of the tire at least in a flange contact range where the tire is in contact with a rim flange (not shown).

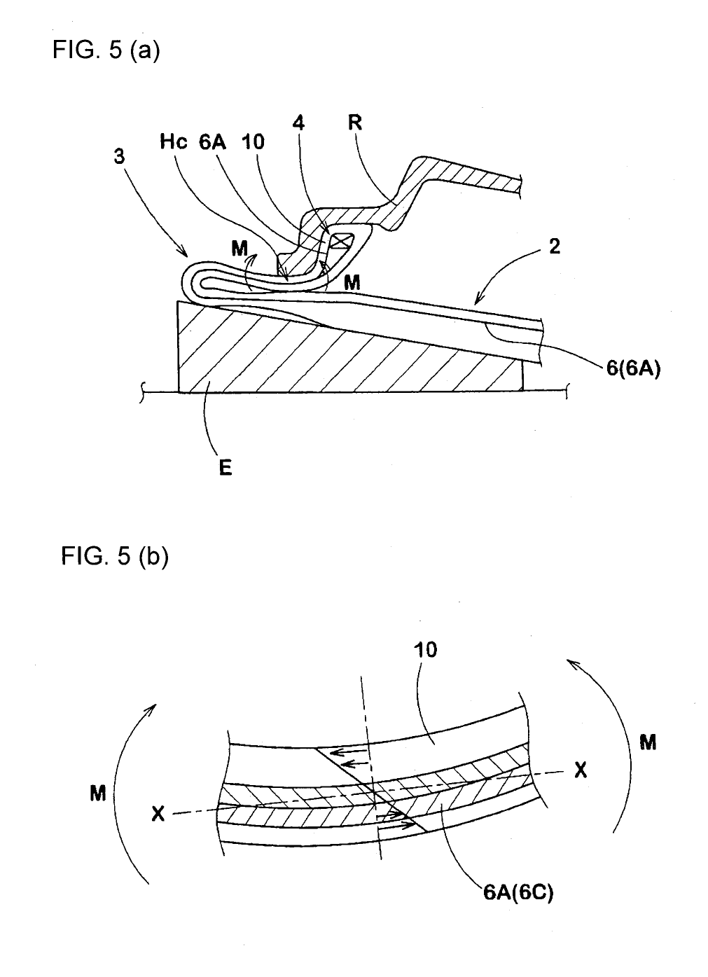

In the present embodiment, the thickness dc of each clinch rubber 10 at a location which is at a height (Hc) of 25 mm from a bead base line (BL) outwardly in the tire radial direction is to be set at 3.0 to 5.0 mm. In other words, for example, when a vehicle runs on a curbstone (E) as shown in FIG. 5(a), the rubber of the bead portion 4 is sandwiched between a rim (R) and the curbstone (E) at the location which is at the height (He). Then, bending deformation (M) is applied to the carcass cords (6c) of the carcass ply (6A) at the location which is at the height (Hc). Here, since the rubber thickness (dc) of the clinch rubber 10 at the location which is at the height (Hc) is set small, namely, at 3.0 to 5.0 mm, the carcass cords (6c) near the location which is at the height (Hc) is located at the neutral axis (X-X) of the bending deformation (M) as shown in FIG. 5(b), and tensile stress applied to the carcass cords (6c) is decreased. Therefore, the pinch cut resistance of the carcass cords (6c) is improved. It should be noted that if the thickness (dc) of each clinch rubber 10 at the location which is at the height (Hc) is less than 3.0 mm, the rigidity of each bead portion 4 is excessively decreased, and the handling stability is deteriorated. In addition, if the thickness (dc) of each clinch rubber 10 at the location which is at the height (Hc) exceeds 5.0 mm, the carcass cords (6c) at each bead portion 4 are located at positions away from the neutral axis (X-X) of the bending deformation (M). Thus, the tensile stress applied to the carcass cords (6c) is increased, and the carcass cords (6c) are fractured. Therefore, the thickness dc of each clinch rubber 10 at the location which is at the height (Hc) is preferably not less than 3.5 mm and preferably not greater than 4.5 mm. Moreover, the weight of the tire whose thickness is defined as described above is low. It should be noted that the thickness of each clinch rubber 10 at the location which is at the height (Hc) is a length in a normal direction of the chafer rubber 17 in the case where the chafer rubber 17 is disposed at the location which is at the height (Hc), and is a length in a normal direction of the carcass ply (6A) in the case where the chafer rubber 17 is not disposed at the location which is at the height (Hc).

A rubber hardness of each of such clinch rubbers 10 is preferably set so as to be the same as the rubber hardness of each bead apex rubber 8. By so doing, wear or damage due to contact with a rim is prevented while the rigidity of each bead portion 4 is kept high. It should be noted that in the present specification, as a matter of course, a case where the rubber hardness of each clinch rubber 10 is exactly the same as the rubber hardness of each bead apex rubber 8 is included, but also a case where a difference between these rubber hardnesses is equal to or less than 7° is included.

Although the pneumatic tire according to an embodiment of the present invention has been described in detail above, it is needless to say that the present invention is not limited to the specific embodiment described above and various modifications can be made to practice the present invention.

### EXAMPLES

Experimental pneumatic tires with a size of 195/65R15 having the basic structure of the tire shown in FIG. 1 were produced on the basis of specifications in Table 1, and pinch cut resistance, handling stability, and tire weight were tested for each experimental pneumatic tire. It should be noted that the main common specifications are as follows.
Ground-contact width TW: 142 mm
Width W1 of first belt ply/TW: 103%
Width W2 of second belt ply/TW: 95%
Carcass cords
   Cord material: polyester
   Cord interval: 0.08 mm
   Cord diameter: 0.54 mm
   Cord angle θ1: 90°
Belt cords
   Cord material: steel
   Cord interval: 0.13 mm
   Cord diameter: 0.54 mm
   Cord angle θ2: 24°
Buttress reinforcing layers
   Cord material: Kevlar (registered trademark)
   Cord diameter: 0.5 mm
Minimum thickness dm of rubber of buttress portion: 4.0 mm
Rubber hardness of clinch rubber: 70°

The test methods are as follows.

### Pinch Cut Resistance

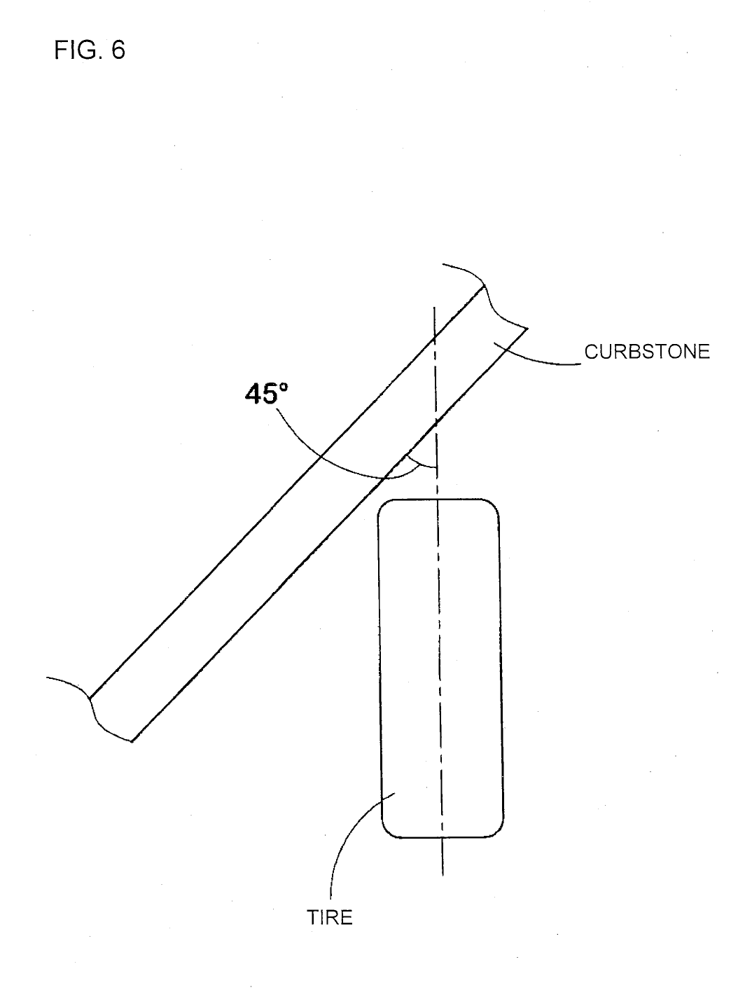

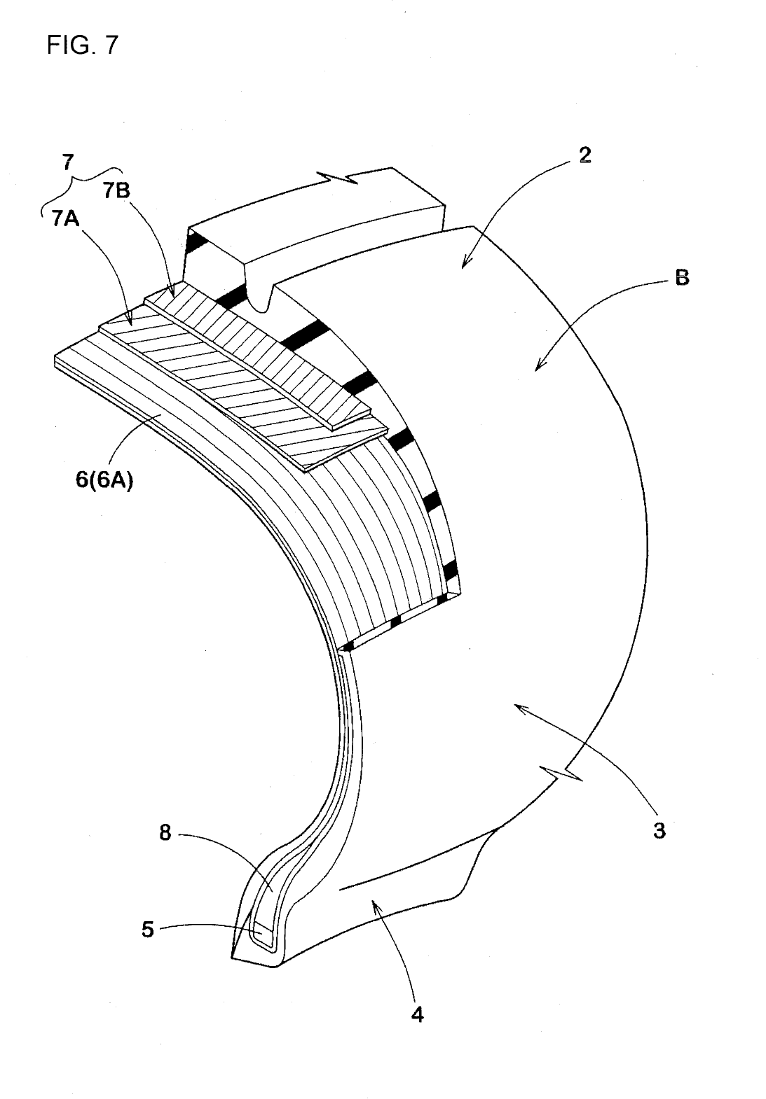

Each experimental tire was mounted to a front wheel of a front wheel drive vehicle produced in Japan with a displacement of 2000 cm³, under the following conditions. As shown in FIG. 6, the experimental tire was caused to approach and run on a curbstone at an angle of 45° with respect to the curbstone and at a speed of 5 km/h. Each of the height and the width of the curbstone was 110 mm. After running on the curbstone, presence/absence of a pinch cut (confirmed by presence/absence of a bubble-like swell in the sidewall portion) was checked. Then, such a test was conducted while the approach speed was increased in increments of 5 km/h, until a pinch cut occurred. The result is indicated as an index based on the approach speed in a conventional example regarded as 100. The higher the value is, the more excellent the pinch cut resistance is.

Rim: 15×6 J

Internal pressure: 230 kPa

### Handling Stability

Four experimental tires were mounted to the above vehicle, one driver drove the vehicle on a dry asphalt road surface in a test course, and handling stability regarding handling responsiveness, rigid impression, and the like was evaluated organoleptically by the driver. The result is indicated as an index based on the result in the conventional example regarded as 100. The higher the value is, the more favorable the result is.

### Tire Weight

The weight of each tire was measured. The result is indicated as an index based on the inverse of the weight in the conventional example regarded as 100. The higher the value is, the more favorable the result is.

The results of the tests are shown in Table 1.

TABLE 1

| | Conventional | | Comp. | | | Comp. | | | |
|---|---|---|---|---|---|---|---|---|---|
| | Example | Ex. 1 | Ex. 1 | Ex. 2 | Ex. 3 | Ex. 2 | Ex. 4 | Ex. 5 | Ex. 6 |
| Thickness dc (mm) at location of | 4.0 | 4.0 | 2.5 | 3.0 | 5.0 | 5.5 | 4.0 | 4.0 | 4.0 |
| height of 25 mm from BL of clinch | | | | | | | | | |
| rubber *1 | | | | | | | | | |
| Width Wa (mm) of overlap portions | — | 7 | 7 | 7 | 7 | 7 | 2 | 5 | 15 |
| Width Wb (mm) of non-overlap | — | 30 | 30 | 30 | 30 | 30 | 30 | 30 | 30 |
| portions | | | | | | | | | |
| Thickness dt (mm) of buttress | — | 0.8 | 0.8 | 0.8 | 0.8 | 0.8 | 0.8 | 0.8 | 0.8 |
| reinforcing layers | | | | | | | | | |
| Angle θ3 (°) of reinforcing cord | — | 50 | 50 | 50 | 50 | 50 | 50 | 50 | 50 |
| with respect to tire circumferential | | | | | | | | | |
| direction | | | | | | | | | |
| Interval Wc (mm) between | — | 0.8 | 0.8 | 0.8 | 0.8 | 0.8 | 0.8 | 0.8 | 0.8 |
| reinforcing cords | | | | | | | | | |
| Tilting directions of reinforcing cords | — | Oppo- | Oppo- | Oppo- | Oppo- | Oppo- | Oppo- | Oppo- | Oppo- |
| and belt cords (same direction or | | site | site | site | site | site | site | site | site |
| opposite directions) | | direc- | direc- | direc- | direc- | direc- | direc- | direc- | direc- |
| | | tions | tions | tions | tions | tions | tions | tions | tions |
| Pinch cut resistance [Index, higher | 100 | 105 | 106 | 106 | 104 | 102 | 103 | 104 | 105 |
| value is better] | | | | | | | | | |
| Handling stability [Index, higher | 100 | 105 | 97 | 102 | 107 | 107 | 103 | 105 | 107 |
| value is better] | | | | | | | | | |
| Tire weight [Index, higher value is | 100 | 95 | 98 | 97 | 93 | 92 | 97 | 96 | 92 |
| better] | | | | | | | | | |
| | Ex. 7 | Ex. 8 | Ex. 9 | Ex. 10 | Ex. 11 | Ex. 12 | Ex. 13 | Ex. 14 | Ex. 15 |
| Thickness dc (mm) at location of | 4.0 | 4.0 | 4.0 | 4.0 | 4.0 | 4.0 | 4.0 | 4.0 | 4.0 |
| height of 25 mm from BL of clinch | | | | | | | | | |
| rubber *1 | | | | | | | | | |
| Width Wa (mm) of overlap portions | 20 | 7 | 7 | 7 | 7 | 7 | 7 | 7 | 7 |
| Width Wb (mm) of non-overlap | 30 | 5 | 10 | 40 | 60 | 30 | 30 | 30 | 30 |
| portions | | | | | | | | | |
| Thickness dt (mm) of buttress | 0.8 | 0.8 | 0.8 | 0.8 | 0.8 | 0.2 | 0.5 | 1.2 | 2.0 |
| reinforcing layers | | | | | | | | | |
| Angle θ3 (°) of reinforcing cord | 50 | 50 | 50 | 50 | 50 | 50 | 50 | 50 | 50 |
| with respect to tire circumferential | | | | | | | | | |
| direction | | | | | | | | | |
| Interval Wc (mm) between | 0.8 | 0.8 | 0.8 | 0.8 | 0.8 | 0.8 | 0.8 | 0.8 | 0.8 |
| reinforcing cords | | | | | | | | | |
| Tilting directions of reinforcing cords | Oppo- | Oppo- | Oppo- | Oppo- | Oppo- | Oppo- | Oppo- | Oppo- | Oppo- |
| and belt cords (same direction or | site | site | site | site | site | site | site | site | site |
| opposite directions) | direc- | direc- | direc- | direc- | direc- | direc- | direc- | direc- | direc- |
| | tions | tions | tions | tions | tions | tions | tions | tions | tions |
| Pinch cut resistance [Index, higher | 106 | 101 | 103 | 105 | 106 | 101 | 104 | 106 | 107 |
| value is better] | | | | | | | | | |
| Handling stability [Index, higher | 108 | 102 | 103 | 106 | 108 | 100 | 103 | 105 | 106 |
| value is better] | | | | | | | | | |
| Tire weight [Index, higher value is | 89 | 99 | 98 | 94 | 89 | 98 | 98 | 93 | 89 |
| better] | | | | | | | | | |
| | Ex. 16 | Ex. 17 | Ex. 18 | Ex. 19 | Ex. 20 | Ex. 21 | Ex. 22 | Ex. 23 | Ex. 24 |
| Thickness dc (mm) at location of | 4.0 | 4.0 | 4.0 | 4.0 | 4.0 | 4.0 | 4.0 | 4.0 | 4.0 |
| height of 25 mm from BL of clinch | | | | | | | | | |
| rubber *1 | | | | | | | | | |
| Width Wa (mm) of overlap portions | 7 | 7 | 7 | 7 | 7 | 7 | 7 | 7 | 7 |
| Width Wb (mm) of non-overlap | 30 | 30 | 30 | 30 | 30 | 30 | 30 | 30 | 30 |
| portions | | | | | | | | | |
| Thickness dt (mm) of buttress | 0.8 | 0.8 | 0.8 | 0.8 | 0.8 | 0.8 | 0.8 | 0.8 | 0.8 |
| reinforcing layers | | | | | | | | | |
| Angle θ3 (°) of reinforcing cord | 35 | 40 | 60 | 65 | 50 | 50 | 50 | 50 | 50 |
| with respect to tire circumferential | | | | | | | | | |
| direction | | | | | | | | | |
| Interval Wc (mm) between | 0.8 | 0.8 | 0.8 | 0.8 | 0.1 | 0.4 | 2.0 | 5.0 | 0.8 |
| reinforcing cords | | | | | | | | | |
| Tilting directions of reinforcing cords | Oppo- | Oppo- | Oppo- | Oppo- | Oppo- | Oppo- | Oppo- | Oppo- | Same |
| and belt cords (same direction or | site | site | site | site | site | site | site | site | direc- |
| opposite directions) | direc- | direc- | direc- | direc- | direc- | direc- | direc- | direc- | tion |
| | tions | tions | tions | tions | tions | tions | tions | tion | |
| Pinch cut resistance [Index, higher | 104 | 105 | 105 | 104 | 107 | 106 | 104 | 102 | 104 |
| value is better] | | | | | | | | | |
| Handling stability [Index, higher | 103 | 104 | 104 | 103 | 106 | 106 | 103 | 101 | 103 |
| value is better] | | | | | | | | | |
| Tire weight [Index, higher value is | 95 | 95 | 95 | 95 | 90 | 93 | 97 | 100 | 95 |
| better] | | | | | | | | | |

*1 BL: bead base line

As a result of the tests, for each tire of each Example, it can be confirmed that each performance is improved in a balanced manner as compared to the Comparative Examples. In addition, when the shapes of the buttress reinforcing layers and the rubber hardnesses of the clinch rubbers were changed within the above-described ranges and tests were conducted, the same tendency as this result of the tests was indicated.

In a pneumatic tire thinned in a buttress portion between a tread portion and each sidewall portion, when the tire is in contact with the ground due to its rolling, interval widening, that is, increasing of the intervals between the carcass cords at the buttress portion occurs, and the rigidity is decreased. Thus, there is a problem that, for example, due to great bending deformation caused such as when the tire runs on a protruding object such as a curbstone, a pitch cut occurs that the carcass cords at this portion are fractured. In addition, the pneumatic tire having low rigidity at the buttress portion also has a problem that the handling stability is deteriorated.

A pneumatic tire according to an embodiment of the present invention has a reinforcing layer provided at each buttress portion, the thickness of each clinch rubber defined within a certain range and has improved pinch cut resistance and handling stability in a balanced manner while the weight thereof is reduced.

According to a first aspect of the present invention, a pneumatic tire includes a carcass extending from a tread portion through sidewall portions to bead cores in bead portions, a belt layer disposed outward of the carcass in a tire radial direction and inward of the tread portion, and clinch rubbers disposed in the bead portions and outward of the carcass in a tire axial direction and forming outer surfaces of the bead portions. The belt layer is formed of multiple belt plies having belt cords tilted at an angle of 15° to 45° with respect to a tire equator. At respective buttress portions on both sides, a pair of buttress reinforcing layers is disposed between the carcass and the belt layer. A thickness of each clinch rubber at a location which is at a height of 25 mm from a bead base line outwardly in the tire radial direction is 3 to 5 mm.

According to a second aspect of the present invention, in the pneumatic tire according to the first aspect, the pair of buttress reinforcing layers has reinforcing cords tilted in a direction opposite to that of a belt cord of an innermost belt ply.

According to a third aspect of the present invention, in the pneumatic tire according to the first aspect, the reinforcing cords of the buttress reinforcing layers are tilted at an angle of 40° to 60° with respect to a tire circumferential direction.

According to a fourth aspect of the present invention, in the pneumatic tire according to the first aspect, bead apex rubbers having a substantially triangular cross-sectional shape are provided so as to extend from the bead cores outwardly in the tire radial direction, and a rubber hardness of each clinch rubber is the same as a rubber hardness of each bead apex rubber.

A pneumatic tire according to an embodiment of the present invention includes: a carcass extending from a tread portion through sidewall portions to bead cores in bead portions; a belt layer disposed outward of the carcass in a tire radial direction and inward of the tread portion; a pair of buttress reinforcing layers disposed between the carcass and the belt layer at respective buttress portions on both sides; and clinch rubbers disposed in the bead portions and outward of the carcass in a tire axial direction and forming outer surfaces of the bead portions.

The belt layer is formed of multiple belt plies having belt cords tilted at an angle of 15° to 45° with respect to a tire equator. Such belt plies tighten the carcass, increase the rigidity of the tread portions, and improve the handling stability. In addition, the pair of buttress reinforcing layers is able to further firmly tighten the carcass. Therefore, the rigidity of the buttress portions is increased, and the handling stability is further improved.

Each clinch rubber is thinned so as to have a thickness of 3 to 5 mm at a location which is at a height of 25 mm from the bead base line outwardly in the tire radial direction. By so doing, the weight of the tire is reduced. In addition, since such clinch rubbers have small thicknesses, carcass cords at each bead portion are located at a neutral axis of bending deformation, and tensile stress applied to the carcass cords is decreased. Therefore, the pinch cut resistance of the carcass cords is improved.

Obviously, numerous modifications and variations of the present invention are possible in light of the above teachings. It is therefore to be understood that within the scope of the appended claims, the invention may be practiced otherwise than as specifically described herein.

What is claimed is:

1. A pneumatic tire having a tread portion, buttress portions, sidewall portions and bead portions, comprising:
a plurality of bead cores positioned in the bead portions, respectively;
a carcass extending from the tread portion through the sidewall portions to the bead cores in the bead portions;
a belt layer formed over the carcass in a tire radial direction in the tread portion and comprising a plurality of belt plies; and
a plurality of clinch rubbers positioned over the carcass in a tire axial direction in the bead portions, respectively, and forming outer surfaces in the bead portions,
wherein each of the belt plies has a plurality of belt cords such that the belt cords are tilted at an angle of 15° to 45° with respect to a tire equator, and each of the clinch rubbers has a thickness in a range of 3 to 5 mm measured at a height of 25 mm from a bead base line in the tire radial direction.

2. The pneumatic tire according to claim 1, further comprising a plurality of buttress reinforcing layers formed between the carcass and the belt layer at the buttress portions, respectively.

3. The pneumatic tire according to claim 2, wherein the buttress reinforcing layers have a plurality of reinforcing cords such that the reinforcing cords are tilted in a direction opposite to a tilt direction of the belt cords of an innermost belt ply of the belt plies.

4. The pneumatic tire according to claim 3, wherein the reinforcing cords of the buttress reinforcing layers are tilted at an angle of 40° to 60° with respect to a tire circumferential direction.

5. The pneumatic tire according to claim 1, further comprising:
a plurality of bead apex rubbers having a substantially triangular cross-sectional shape and extending from the bead cores in the tire radial direction,
wherein each of the clinch rubbers has a rubber hardness which is same as a rubber hardness of each of the bead apex rubbers.

6. The pneumatic tire according to claim 2, further comprising:
a plurality of bead apex rubbers having a substantially triangular cross-sectional shape and extending from the bead cores in the tire radial direction,
wherein each of the clinch rubbers has a rubber hardness which is same as a rubber hardness of each of the bead apex rubbers.

7. The pneumatic tire according to claim 3, further comprising:
a plurality of bead apex rubbers having a substantially triangular cross-sectional shape and extending from the bead cores in the tire radial direction,
wherein each of the clinch rubbers has a rubber hardness which is same as a rubber hardness of each of the bead apex rubbers.

8. The pneumatic tire according to claim 4, further comprising:
a plurality of bead apex rubbers having a substantially triangular cross-sectional shape and extending from the bead cores in the tire radial direction,
wherein each of the clinch rubbers has a rubber hardness which is same as a rubber hardness of each of the bead apex rubbers.

9. The pneumatic tire according to claim 2, wherein the buttress reinforcing layers have a plurality of reinforcing cords formed such that a cord interval between the reinforcing cords is in a range of from 0.4 mm to 1.7 mm.

10. The pneumatic tire according to claim 1, further comprising:
a plurality of buttress reinforcing layers formed between the carcass and the belt layer at the buttress portions, respectively,
wherein the plurality of buttress reinforcing layers is formed such that each of the buttress reinforcing layers forms an overlapping portion overlapping with the belt layer and forming an inner edge and a non-overlapping portion not overlapping with the belt layer and forming an outer edge.

11. The pneumatic tire according to claim 1, wherein each of the buttress reinforcing layers forms the overlapping portion which has a width in a range of from 5 mm to 15 mm.

12. The pneumatic tire according to claim 1, wherein each of the buttress reinforcing layers forms the non-overlapping portion which has a width in a range of from 12 mm to 40 mm.

13. The pneumatic tire according to claim 1, wherein each of the buttress reinforcing layers forms the overlapping portion which has a width in a range of from 5 mm to 15 mm and the non-overlapping portion which has a width in a range of from 12 mm to 40 mm.

14. The pneumatic tire according to claim 2, wherein the buttress reinforcing layers have a plurality of reinforcing cords such that the reinforcing cords are tilted in a direction opposite to a tilt direction of the belt cords of an innermost belt ply of the belt plies, and the reinforcing cords are formed such that a cord interval between the reinforcing cords is in a range of from 0.4 mm to 1.7 mm.
